(19) United States
(12) Patent Application Publication
(10) Pub. No.: US 2023/0344060 A1
(43) Pub. Date: Oct. 26, 2023

(54) A BATTERY BLOCK

(71) Applicant: TVS MOTOR COMPANY LIMITED, Chennai, MI (US)

(72) Inventors: Thangarajan Sivanesaselvam, Chennai (IN); Subbiah Senthilnathan, Chennai (IN); Jabez Dhinagar Samraj, Chennai (IN)

(73) Assignee: TVS MOTOR COMPANY LIMITED, Chennai (IN)

(21) Appl. No.: 17/916,486

(22) PCT Filed: Mar. 19, 2021
(86) PCT No.: PCT/IN2021/050286

§ 371 Date: Sep. 30, 2022

(30) Foreign Application Priority Data
Apr. 1, 2020 (IN) 202041014643

(51) Int. Cl. H01M 50/262; H01M 50/209; H01M 50/509

(52) U.S. Cl. CPC H01M 50/262; H01M 50/209; H01M 50/509; H01M 2010/4271

(57) ABSTRACT

A battery block includes: battery modules that each include a cell holder with a connecting socket and a plurality of cells in the cell holder connected in at least one of a series and a parallel connection; a connector key with annuli positioned in-line with the connecting socket in the cell holder of the sequentially positioned battery modules, where the connector key holds the battery modules adjacent to each other; and attaching components that are removably engaged in the annuli of the connector key, where the attaching components stack the battery modules in at least one of the horizontal direction and the vertical direction. The battery modules are sequentially positioned in at least one of a horizontal direction and a vertical direction.

### TECHNICAL FIELD

The present subject matter relates to battery modules. More particularly, a battery block of the battery modules is disclosed.

### BACKGROUND

Existing research in battery technology is directed to rechargeable batteries, such as sealed, starved electrolyte, lead/acid batteries, are commonly used as power sources in different applications, such as, vehicles and the like. However, the lead-acid batteries are heavy, bulky, and have short cycle life, short calendar life, and low turn around efficiency, resulting in limitations in applications.

Thus, in order to overcome problems associated with conventional energy storage devices including the lead-acid batteries, a lithium ion battery provides an ideal system for high energy-density applications, improved rate capability, and safety. Further, the rechargeable energy storage devices—lithium-ion batteries exhibit one or more beneficial characteristics which makes it useable on powered devices. First, for safety reasons, the lithium ion battery is constructed of all solid components while still being flexible and compact. Secondly, the energy storage device including the lithium ion battery exhibits similar conductivity characteristics to primary batteries with liquid electrolytes, i.e., deliver high power and energy density with low rates of self-discharge. Thirdly, the energy storage device as the lithium ion battery is readily manufacturable in a manner that it is both reliable and cost-efficient. Finally, the energy storage device including the lithium ion battery is able to maintain a necessary minimum level of conductivity at sub-ambient temperatures.

However, for increased energy capacity requirements, many such energy storage devices need to be electrically connected together in series. In higher energy capacity applications where the batteries drive the system, such as vehicles, the series connected batteries have to be compactly arranged due to the space constraints.

Thus, there is a need to mechanically stack the energy storage devices for electrically connecting them to meet higher energy requirements.

### BRIEF DESCRIPTION OF DRAWINGS

The detailed description is described with reference to the accompanying figures. The same numbers are used throughout the drawings to reference like features and components.

FIG. 1 exemplarily illustrates a perspective view of an embodiment of battery block;

FIG. 2 exemplarily illustrates a perspective view of a cell holder of a battery module in the battery block;

FIGS. 3A-3B exemplarily illustrate enlarged partial perspective views of the battery block;

FIG. 4A-4B exemplarily illustrate a partially exploded perspective view of the battery block depicting connecting members and an enlarged perspective view of a connecting key of one of the connecting members respectively;

FIGS. 5A-5B exemplarily illustrate sectional view of the battery block and assembly of the connector key and attaching components respectively; and

FIG. 6 exemplarily illustrates a flowchart depicting a method of assembly of a battery block exemplarily illustrated in FIG. 1.

### DETAILED DESCRIPTION OF THE INVENTION

In known mechanical stacking of energy storage devices, connecting rods that run along the length of the stack energy storage devices from a first energy storage to a last energy storage device are disclosed. However, such connecting rods require protrusions from the casing of individual energy storage devices to pass through and be fastened to the ends of the first and the last energy storage devices. In such an implementation, since the connecting rod is in close proximity to the casing of the energy storage devices, there are chances of a large short circuit current to flow between the casing of the energy storage devices and the connecting rod. At higher temperatures, the casings may expand and the protrusions from the casing may deform. The connecting rod may no longer be able to hold the stack intact. If the fasteners at the end of the connecting rod bend due to the deformation of the protrusions and happen to contact the external casing of the energy storage devices, a short circuit current may flow which is detrimental to the energy storage devices and compromise the safety of the energy storage devices.

In applications with demanding output from the stack of the energy storage devices, if the output of the stack deteriorates due to short circuit, it is detrimental to the performance of the application, such as, the vehicle. Thus, there is a need to insulate the energy storage devices from contacting each other and the connecting rod for safe operation of the stack of the energy storage devices. Also, producing casings with protrusions would require a change in existing tooling for production of the casing of the energy storage device, resulting in additional tooling cost and manufacturing cost in production of such casings.

If incase the connecting rod is attached to the external casing of the energy storage devices by means of welding, the compressive forces to hold the stack of the energy storage devices together may not be sufficient, resulting in not-so-compact packaging of the energy storage devices. When used in automotive applications, the binding of the connecting rod to the casing of the energy storage devices may not be robust due to the vibration and the mechanical shock. Also, the replaceability of the energy storage devices is affected and entire stack needs to be discarded, if one of the energy storage devices turns out faulty.

To alleviate the short circuiting in the stack, if the insulator plates are positioned between the energy storage devices and between the energy storage devices and the connecting rod, the stack of the energy storage devices may turn out bulky requiring more space and more compressive forces. Also, under high compressive forces, with the connecting rod connected to the ends of the stack, there is high probability for the stress to concentrate at the upper edges of the casings of the first and the last energy storage device, resulting in deformation or leak of the energy storage devices. This may be catastrophic to the entire stack and may require its replacement as a whole.

To avoid the stress at the ends of the stack, if support structures are positioned at the ends of the stack and the connecting rod extends from one support structure at one end to another support structure at another end, there are increased number of parts in the stack, again making it heavy and bulky. Also, there is difficulty in manufacturing, assembly, installation, and servicing of such a stack with increased cost involved with each of the activities.

Thus, there exists a need for a stack of the energy storage devices that is mechanically stable, compact, thermally stable, durable, vibration resistant, and impact resistant overcoming all problems disclosed above as well as other problems of known art.

The present subject matter discloses a stack of energy storage devices, that is, the battery modules assembled for impact resistance, shock isolation, and vibration dampening of the stack. Such a stack of the battery modules may be employed in powered devices, such as, vehicles, for example, electric vehicle, hybrid electric vehicles, IC engine vehicles, requiring multiple battery modules to be connected in series and parallel to meet requirements of the applications.

In an embodiment of the present invention, a battery block is disclosed. The battery block comprises two or more battery modules. Each of the battery modules comprises at least one cell holder with at least one connecting socket. Further, each battery module comprises multiple cells connected in series and/or parallel connection in the cell holders. The battery block further comprises at least one connector key with annuli positioned in-line with the connecting sockets in the cell holders of sequentially positioned battery modules for holding the battery modules adjacent. Further, the battery block comprises at least two attaching components that removably engage in the annuli of the connector key for stacking the battery modules in a vertical and/or a horizontal direction.

In another embodiment, a method of assembly of the battery block is disclosed. The method comprises steps of obtaining two or more battery modules. Each of the battery modules comprises at least one cell holder with at least one connecting socket and multiple cells in the cell holders connected in a series and/or a parallel connection. In the next step, the battery modules are positioned sequentially in a horizontal direction and/or a vertical direction. Next, at least one connector key with annuli is positioned in-line with the connecting sockets in the cell holders of the sequentially positioned battery modules for holding the battery modules adjacent to each other. Further, the connector keys are fastened with at least two attaching components removably engaged in the annuli of the connector keys for stacking the battery modules in the horizontal direction and/or the vertical direction.

An energy storage device comprises one or more energy storage cells, such as, lithium ion battery cells enclosed within a casing. The energy storage device may be used in driving electric vehicles or hybrid electric vehicles. For higher capacity requirements, such as, driving the electric vehicles, multiple energy storage devices would be required. These multiple energy storage devices are electrically connected in series to output higher capacity. In an embodiment, these energy storage devices may be distantly located in the vehicle at different locations. In another embodiment, the energy storage devices may be co-located. The energy storage devices that are co-located are mechanically connected to each other or stacked for compact packaging of the energy storage devices in high capacity requirement applications.

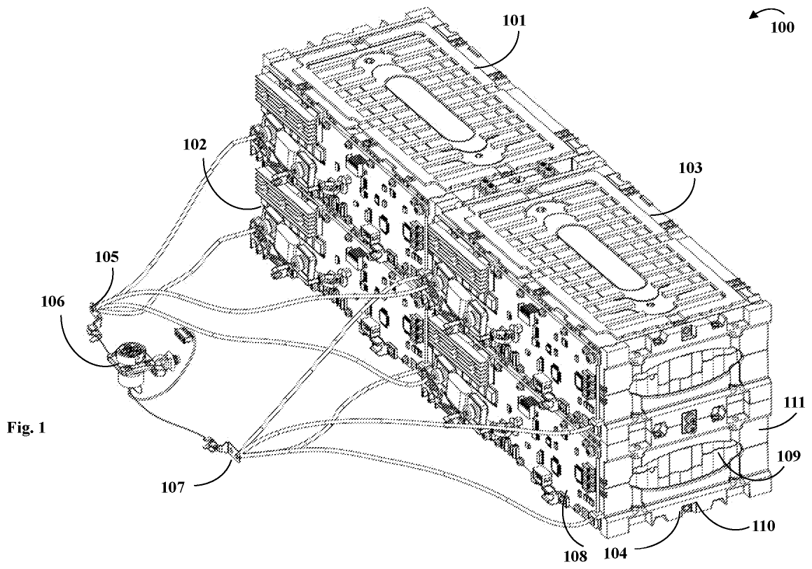

FIG. 1 exemplarily illustrates a perspective view of an embodiment of battery block 100. As referred herein, a “battery block” refers to a mechanical connection of multiple battery modules 101, 102, 103, and 104 in a vertical direction and/or a horizontal direction. That is, the battery block 100 may comprise individual battery modules 101, 102, 103, and 104 that are stacked one above the other and/or one next other at the same level. As exemplarily illustrated, the battery modules 101, 102, 103, and 104 are co-located and are stacked to form the battery block 100. The battery modules 101 and 102 are vertically stacked and the battery modules 103 and 104 are vertically stacked. The battery modules 101 and 103 are stacked horizontally and the battery modules 102 and 104 are also stacked horizontally. As exemplarily illustrated, the battery modules 101, 102, 103, and 104 are electrically connected in parallel. The positive terminals of the battery modules 101, 102, 103, and 104 are connected to the positive terminal 105 of a power connector 106. Similarly, the negative terminal of the battery modules 101, 102, 103, and 104 are connected to the negative terminal 107 of the power connector 106. Subsequently, the power connector may be connected to a control unit or driven entity, such as, a motor. In an embodiment, the battery modules 101, 102, 103, and 104 forming the battery block 100 may be connected in a series connection.

The electrical connections, that is, the positive terminal and the negative terminal of each of the battery modules 101, 102, 103, and 104 originates from a battery management system (BMS) 108 of each of the battery modules 101, 102, 103, and 104. Each of the battery modules 101, 102, 103, and 104 comprises multiple cells, such as, 109 arranged in a particular sequence between one or more cell holders 110 and 111. The cells 109 are electrically connected in series and/or parallel configuration to form an array of cells. Such arrays of cells 109 are electrically connected to the BMS 108 within the battery module, such as, 104. The BMS 108 is a printed circuit board with one or more integrated circuits integrally built on it. The battery module, such as, 104 has mounting provisions for the BMS board 108. The BMS board 108 is screwably attached to the cell holders 110 and 111 of the battery module 104. In an embodiment, the BMS board comprises a heat sink (not shown) that monitors and maintains the health of the cells 109. In an embodiment, each battery module, such as, 104 may comprise only one cell holder such as, 110 holding the cells 109.

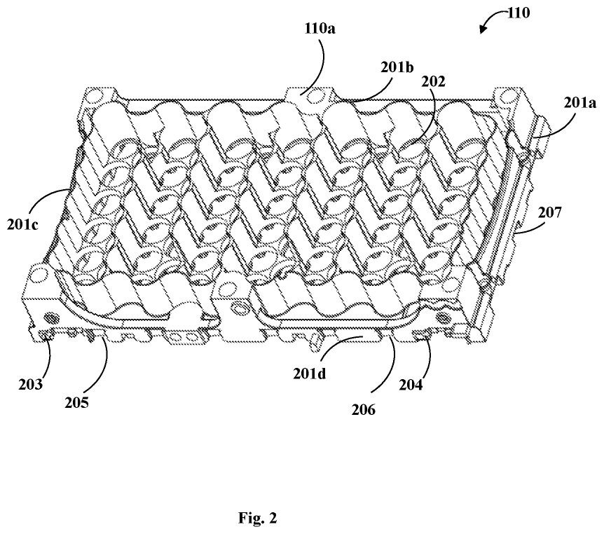

The cell holders, such as, 110 and 111 of each of the battery modules, such as, 104 have provisions, such as, connecting sockets as exemplarily illustrated in FIG. 2, for mechanically connecting the battery modules 101, 102, 103, and 104 to form the battery block 100. In an embodiment, two battery modules such as 101 and 102 or 101 and 103 may also form a battery block. In another embodiment, the three battery modules, such 101, 102 and 104 or 102, 104, and 103, or 101, 103, and 102 or 101, 103, and 104 may form a battery block. In an embodiment, the battery block, such as, 100 may further comprise a casing (not shown). The casing may enclose the battery modules 101, 102, 103, and 104 that are stacked in the horizontal direction or/and the vertical direction.

FIG. 2 exemplarily illustrates a perspective view of a cell holder 110 of a battery module, such as, 104 in the battery block 100 as exemplarily illustrated in FIG. 1. The other battery modules 101, 102, and 103 in the battery block 100 exemplarily illustrated in FIG. 1 also have a similar construction as will disclosed in the detailed description of FIG. 2. As disclosed earlier, the battery module 104 comprises the cell holders 110 and 111 and the BMS board 108 removably attached to the cell holders 110 and 111. The cell holder 110 is a bottom cell holder and the cell holder 111 is a top cell holder. Each of the cell holders, such as, 110 comprise placeholders 202 for holding the cells 109 in each placeholder 110. Each of the cell holders 110 comprises a planar surface, such as, 110a with the placeholders 202 and raised walls, such as, 201a, 201b, 201c, and 201d at the sides of the planar surface 110a. The bottom cell holder 110 is positioned at the bottom of the cells 109 and the top cell holder 111 is positioned on top of the cells 109. The cell holders 110 and 111 are fixed together using a plurality of fasteners to tightly hold the cells 109 in the placeholders 202. The raised walls, such as, 201a, 201b, 201c, and 201d of the cell holders, such as, 110 come in contact with each other, when the cell holders 110 and 111 are fixed together. To fasten the cell holders 110 and 111 together, recesses such as, 201 to position the fasteners are provided in the cell holders 110 and 111.

As an embodiment, the cell holders 110 and 111 may be rectangular in shape and holding cylindrical cells 109 in the placeholders 202. The bottom cell holder 110 is exemplarily illustrated in FIG. 2. The construction of the top cell holder is similar to the construction of the bottom cell holder exemplarily illustrated on FIG. 2. As exemplarily illustrated, the cell holder 110 have two first raised walls 201a and 201c and two second raised walls 201b and 201d. The first raised walls 201a and 201c are shorter in length compared to the second raised walls 201b and 201d. The BMS board 108 is screwably attached to the cell holders 110 at one of the second raised walls, such as, 201b of the cell holder 110. There are recesses such as, 205 and 206 that form connecting sockets of the cell holder 110. At predetermined locations of the cell holder, the connecting sockets are formed on the cell holders as recesses, depressions, or as a part of the cell holder is excavated. At the connecting sockets, apertures are formed for receiving connecting members for mechanically connecting the battery modules 101, 102, 103, and 104 to form the battery block 100. The cells, such as, 109 in the cell holders 110 and 111 of a battery module, such as 103, are electrically insulated from the cells, such as 109 in the cell holders 110 and 111 of the other battery modules, such 101, 102, and 104 by the raised walls 201a, 201b, 201c, and 201d of the cell holders 110 and 111 of the battery modules 101, 102, 103, and 104.

In an embodiment, the cell holder 110 may only one connecting socket, such as, 205 on either of the second raised walls 201b and 201d or the first raised walls 201a and 201c. In another embodiment, the cell holder 110 may comprise multiple connecting sockets, 205, 206, 207 formed in the raised walls such as, 201d and 201a of the cell holder 110. The first raised wall 201c may have similar connecting socket, such as, 207. The other second raised wall 201b has recesses, such as, 203 and 204 that form the electrical connections of the cells 109 that are extended to the BMS board 108 of the battery module 104. Further the second raised wall 201b also has recesses (not shown) for screwably attaching the BMS board 108.

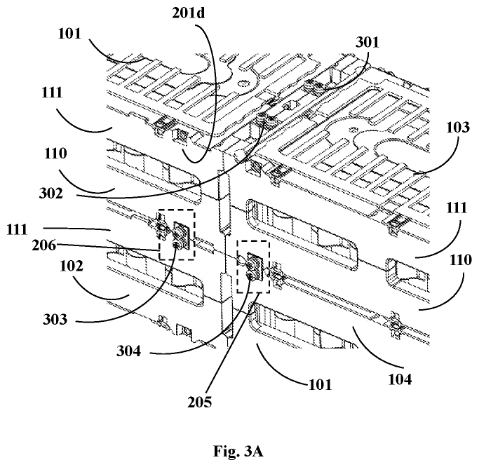

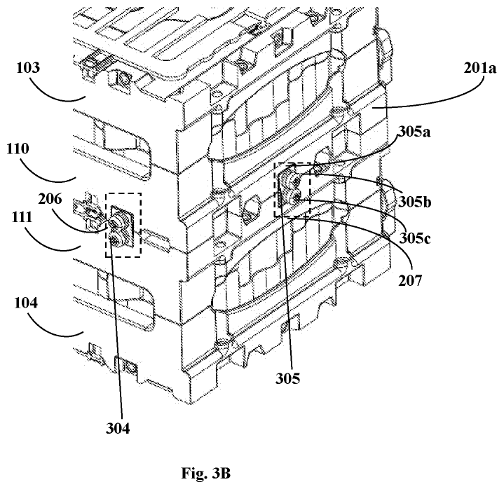

In yet another embodiment, the cell holder 110 may comprise one connecting socket, such as, 205 on each of the raised walls 201a, 201c, and 201d of the cell holder 110. The connecting sockets, such as, 205, 206, 207 are formed in the first raised walls 201a, 201c and a second raised wall 201d. Further, in an embodiment, the connecting socket, in construction same as 205, may be formed on a rear side of the planar surface 110a of the cell holder 110. That is, the connecting sockets may be formed on the rear side of the placeholders 202 of the cell holder 110 as exemplarily illustrated in FIG. 3A. The connecting socket, such as, 205 facilitates mechanical connection of the battery module 103 with such a cell holder 110 to one or more other battery modules 104 and 101 to form a battery block, such as, 100 as exemplarily illustrated in FIG. 1.

In an embodiment, the connecting sockets, such as, 205, 206, 207, are on four sides of the cell holder 110. That is, the connecting sockets 205, 206, 207 are on the first raised walls 201a and 201c, the second raised wall 201d, and on rear (not shown) of the planar surface 110a. On the rear of the planar surface 110a, the connecting sockets are located proximal to the first raised walls 201a and 201c of the cell holder 110. In an embodiment, only one connecting socket, such as, 205 may be formed at the center of the raised walls 201a, 201c and 201d and proximal to the first raised walls 201a and 201c on the rear of the planar surface 110a. In another embodiment, the connecting socket, such as, 205 may be formed proximal to vertices of the cell holder 110. In another embodiment, two connecting sockets 205 and 206 on each raised wall 201a, 201c, and 201d may be formed symmetrical about the centerline of the raised wall 201a, 201c, and 201d. The connecting sockets (not shown) on the rear of the planar surface 110a are also formed symmetrical about the centerline of the first raised walls 201a and 201c. In an embodiment, with more than three connecting sockets, the three connecting sockets on each raised wall 201a, 201c, and 201d of the cell holder 110 are equidistantly located. The symmetrical or equidistantly located connecting sockets 205 and 206 offer symmetry to apply tension in holding multiple battery modules 102, 103, and 104 together. The connecting sockets, such as, 205, 206, 207 on the four sides of the cell holder 110 allow connection of the battery module 104 to other battery modules, such as, 102 and 103 on two sides of the cell holder 110.

For stacking of a battery module, such as, 102 next to the battery module 104, the top cell holder 110 and the bottom cell holder 111 of each of the battery modules 102 and 104 comprises connecting sockets, such as, 205 and 206 on the rear of the planar surface proximal to the first raised walls, such as, 201a and 201c. For stacking a battery module 103 over another battery module 104, the top cell holder, such as, 111 of the battery module 104 comprises connecting sockets, such as, 205, 206, 207 on the second raised wall, such as, 201d and the first raised walls, 201a and 201c and the bottom cell holder 110 of the other battery module 103 comprises connecting sockets 205, 206, 207 on the second raised wall , such as, 201d and the first raised walls, 201a and 201c as exemplarily illustrated in FIGS. 3A-3B.

FIGS. 3A-3B exemplarily illustrate enlarged partial perspective views of the battery block 100 illustrated in FIG. 1. As exemplarily illustrated in FIG. 3A, the battery modules 101 is positioned above battery module 102. The battery module 103 is positioned above the battery module 104. The battery module 101 and battery module 103 are positioned side-by-side. Similarly, the battery modules 102 and 104 are positioned side-by-side. The battery modules 101 and 103 are fastened to each other using connecting members such as, 301 and 302 at the connecting sockets on the rear surface of the planar surface of the cell holder 111. The battery modules 101 and 102 are fastened to each other using the connecting member 303 at the connecting sockets, such as, 205 and 206 on the second raised walls, such as, 201d, as exemplarily illustrated in FIG. 2, of the cell holders 110 and 111 of the battery modules 101 and 102. Similarly, the battery modules 103 and 104 are fastened to each other using the connecting member 304 at the connecting sockets, such as, 205 and 206 on the second raised walls, such as, 201d of the cell holders 110 and 111 of the battery modules 103 and 104. The battery modules 102 and 104 are not fastened to each other. The location of the connecting sockets, such as, 205, 206, 207 is indicated dashed boxes in FIGS. 3A-3B.

As exemplarily illustrated, the connecting sockets, such as, 205 and 206 on the rear of the planar surface of the cell holder 111 are positioned proximal to each other. The connecting sockets, such as, 205 and 206 are formed symmetrical about the center line of the first raised walls of the cell holder 111 of the battery modules 101 and 103. The connecting sockets, such as, 205 and 206 in the cell holder 111 of the battery modules 101 and 103 are positioned in-line with each other for the aperture in the connecting sockets, such as, 205 and 206 to be in-line or aligned. In each pair of the connecting sockets, such as, 205 and 206 of the battery modules 101 and 103 that are in-line, the connecting members 301 and 302 are positioned and the battery modules 101 and 103 are fastened together.

Further, for connecting the battery modules 101 and 102, the connecting sockets, such as, 205 and 206 on the bottom cell holder 110 of the battery module 101 and the top cell holder 111 of the battery module 102 are positioned proximal to each other. The connecting sockets, such as, 205 and 206 are formed symmetrical about the center line of the second raised walls of the cell holders 110 and 111 of the battery modules 101 and 102 respectively. The connecting sockets, such as, 205 and 206 in the cell holder 110 and 111, of the battery modules 101 and 102 respectively, are positioned in-line with each other for the aperture in the connecting sockets, such as, 205 and 206, to be in-line. In each pair of the connecting sockets, such as, 205 and 206 of the battery modules 101 and 102 that are in-line, the connecting member 303 is positioned and the battery modules 101 and 102 are fastened together.

Similarly, for connecting the battery modules 103 and 104, the connecting sockets, such as, 205 and 206 on the bottom cell holder 110 of the battery module 103 and the top cell holder 111 of the battery module 104 are positioned proximal to each other. The connecting sockets, such as, 205 and 206 in the cell holder 110 and 111 of the battery modules 103 and 104 respectively are positioned in-line with each other for the aperture in the connecting sockets, such as, 205 and 206 to be in-line. In each pair of the connecting sockets, such as, 205 and 206 of the battery modules 103 and 104 that are in-line, the connecting member 304 is positioned and the battery modules 103 and 104 are fastened together.

As exemplarily illustrated in FIG. 3B, the battery modules 103 and 104 are also fastened together using the connecting socket 207 on the first raised wall 201a, as exemplarily illustrated in FIG. 2, of the bottom cell holder 110 of the battery module 103 and the top cell holder 111 of the battery module 104. The connecting socket 207 of the bottom cell holder 110 of the battery module 103 and the top cell holder 111 of the battery module 104 are positioned proximal to each other. The connecting socket, such as, 207 is formed centrally in the first raised walls of the cell holders 100 and 111 of the battery modules 103 and 104 respectively. The connecting socket, such as, 207 in the cell holder 110 and 111 of the battery modules 103 and 104 respectively are positioned in-line with each other for the aperture in the connecting socket, such as, 207 to be in-line or aligned. In the pair of the connecting sockets, such as, 207 of the battery modules 103 and 104 that are in-line, a connecting member 305 is positioned and the battery modules 103 and 104 are fastened together. Thus, the battery modules 103 and 104 are fastened together using the connecting member 304 on the second raised walls of the cell holders 110 and 111 and the connecting member 305 on the first raised walls of the cell holders 110 and 111.

Each of the connecting member, such as, 301, 302, . . . 305 comprises at least one connector key with annuli and at least two attaching components that removably engage in the annuli of the connector key for fastening the battery modules 101, 102, 103, and 104 to form the battery stack 100. As exemplarily illustrated, the connecting member 305 comprises one connector key 305a with two annuli that engage two attaching components 305b and 305c. The annuli of the connector key 305a are in-line with the aperture of the connecting socket, such as, 207 in each of the cell holders 110 and 111 of the battery modules 103 and 104 respectively.

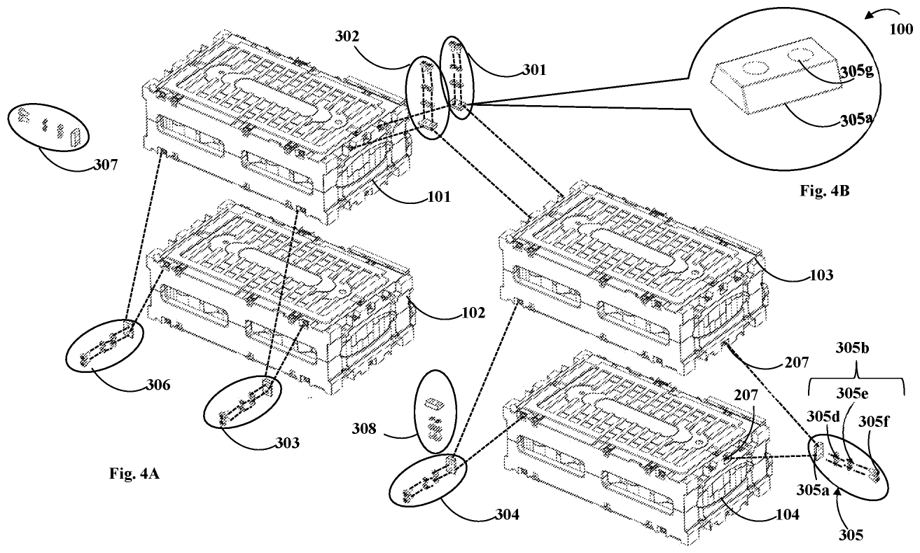

FIG. 4A-4B exemplarily illustrate a partially exploded perspective view of the battery block 100 depicting connecting members such as 301, 302, . . . 308, and an enlarged perspective view of a connector key 305a of one of the connecting members, such as, 305 respectively. As exemplarily illustrated, the battery modules 101, 102, 103, and 104 are stacked together using the connecting members such as, 301, 302, . . . , 308 to form the battery block 100 as disclosed in the detail description of FIGS. 3A-3B. The positioning of the connecting members, 301, 302, . . . , 308 in the connecting sockets, such as, 205, 206, 207 of the top cell holder, such as, 111 and the bottom cell holder, such as, 110 of the battery modules 101, 102, 103, and 104 is shown in the dashed lines. Each of the connecting members, such as, 305 includes the connector key, such as, 305a with the annuli 305g and the attaching components 305b, 305c that engage in the annuli 305g. The connector key 305a interlocks the battery modules 103 and 104 in the connecting sockets, 207 of the respective cell holders, such as, 110 and 111 of each of the battery modules 103 and 104. The attaching components 305b, 305c fasten the connector key 305a at the connecting socket 207 to fasten the battery modules 103 and 104 together to form the battery block.

In an embodiment, the attaching components 305b, 305c, are an assemblage of screws 305f, spring washers 305e, and plain washers 305d, that engage in the annuli 305g of the connector key 305a and the aperture of the connecting socket 207 of the cell holders 110 and 111 of the battery modules 103 and 104. The threaded portion of the screw 305f grooves into the aperture of the connecting socket 207. The plain washers 305d and the spring washers 305e help distribute the load of the screws 305f that impinges on the connector key 305a and the cell holders 110 and 111. The spring washers 305e prevents loosening and displacement of the connecting member 305 at the connecting socket 207 due to vibrations and mechanical shocks, by providing better locking capabilities.

In another embodiment, the attaching components may be rivets with a flathead that penetrate through the aperture of the connecting socket 207. The attaching components may be made of stainless steel with less corrosive properties and offering better mechanical strength.

As exemplarily illustrated in FIG. 4B, the connector key 305a comprises the annuli 305g that are in-line with the aperture of the connecting socket 207. The connector key 305a is a trapezoidal insert e.g. made of metal whose thickness is same as the depth of the connecting socket 207 in the cell holders 110 and 111. In an embodiment, the connector key 305a may be rectangular, circular, etc., in shape. On placing the connector key 305a at the connecting socket 207, the connector key 305a exactly fits into the connecting socket 207 of the cell holders 110 and 111. The dimensions, that is, the length and the breadth of the connector key 305a are equal to the dimensions of the connecting socket 207 of the two cell holders 110 and 111 put together.

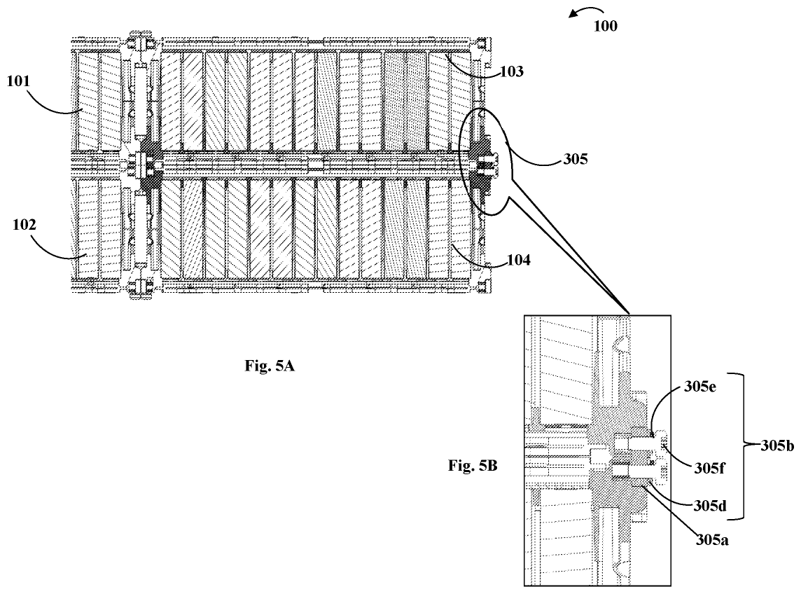

FIGS. 5A-5B exemplarily illustrate sectional view of the battery block 100 and assembly of the connector key, such as, 305a and the attaching components 305b, 305c respectively. The connecting sockets, such as, 205, 206, 207 of the cell holders 110 and 111 have a design for matching the profile of the connector key, such as, 305a. The cell holders 110 and 111 are typically made of a polymer or a resin material and molded in a manner to form the connecting sockets, such as, 205, 206, 207 with the aperture. The molded connecting sockets, such as, 207 of two cell holders 110 and 111 of two adjacent battery modules, such as, 103 and 104 receive the metal insert, that is, the connector key 305a. The connector key 305a is fastened in the connecting sockets 207 using the attaching components 305b, 305c. Each annulus 305g in the connector key 305a is in-line with the aperture of the connecting socket 207 of each of the cell holders 110 and 111 of the different battery modules 103 and 104. Each screw 305f with a plain washer 305d and a spring washer 305e is inserted into the annulus 305g of the connector key 305a and tightened to tightly hold the connector key 305a at the connecting sockets 207 of the two battery modules 103 and 104. The tightened connector key 305a holds the battery modules 103 and 104 and other battery modules 101 and 102 together to form the battery block 100. The connecting sockets 207, the connector key 305a, and the attaching components 305b, 305c ensure the degree of alignment of the battery modules 101, 102, 103, and 104 to form the battery block 100 to be very precise. Thus, the battery block 100 has the battery modules 101, 102, 103, and 104 stacked in a horizontal direction or a vertical direction or both.

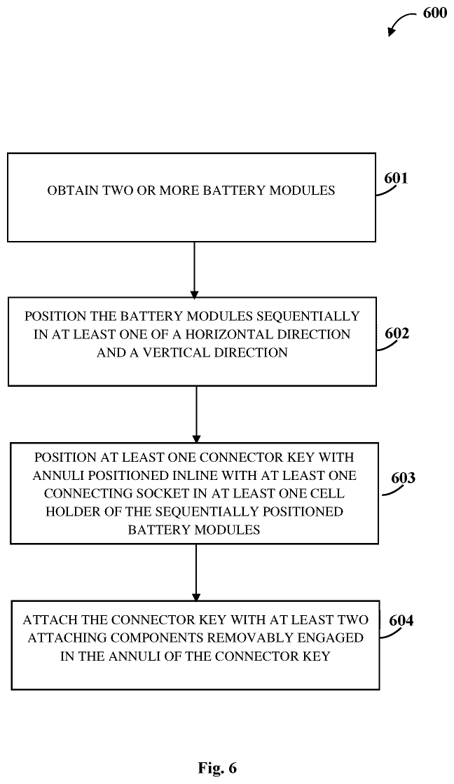

FIG. 6 exemplarily illustrates a flowchart 600 depicting a method of assembly of a battery block 100 as exemplarily illustrated in FIG. 1. At step 601, the two or more battery modules, such as, 101, 102, 103, and 104 are obtained. Each of the battery modules comprises at least one cell holder, such as, 110 and 111 with at least one connecting socket, such as, 207 as disclosed in detailed description of FIG. 2. Further, the battery modules, such as, 101, 102, 103, and 104 comprise multiple cells 109 in the cell holders, such as, 110 and 111 connected in at least one of a series and a parallel connection. Further, at step 602, the battery modules, such as, 101, 102, 103, and 104 are sequentially positioned in a horizontal direction or/and a vertical direction. At step 603, at least one connector key, such as, 305a is positioned with annuli 305g in-line with the connecting socket, such as, 207 in the cell holders 110 and 111 of the sequentially positioned battery modules, such as, 101 and 103 and 102 and 104, . . . , 103 and 104 for holding the battery modules 101 and 103 and 102 and 104, . . . 103 and 104 adjacent. At step 604, the at least one connector key, such as, 305a is attached with at least two attaching components, such as, 305b, 305c removably engaged in the annuli 305g of the at least one connector key, such as, 305a for stacking the battery modules, such as, 101, 102, 103, and 104 in the horizontal direction or/and the vertical direction to form the battery block 100.

For stacking the battery modules 101 and 103 horizontally, one of the at least one connector key 305a is positioned in-line with one of the at least one connecting socket, such as, 207 rear of a planar surface of the top cell holder 111 of the first battery module, that is, 101 and one of the at least one connecting socket, such as, 207 rear of a planar surface of the top cell holder 111 of the second battery module 103 as exemplarily illustrated in FIGS. 3A-3B.

For stacking the battery modules 103 and 104 vertically, the at least one connector key 305a is positioned in-line with at least one connecting socket, such as, 205 and 206 in a raised wall 201d of the bottom cell holder 110 of the first battery module 103 and the at least one connecting socket, such as, 205 and 206 in a raised wall 201d of the top cell holder 111 of the second battery module 104 as exemplarily illustrated in FIGS. 3A-3B.

The battery block and the method of assembling the battery block disclosed herein provides technical advancement in the field of battery technology in high capacity requirements as follows: Such a method of assembly of the battery modules allows for the flexibility in stacking the battery modules in a horizontal direction and/or vertical directions, based on the application. The application dictates the space constraints and the capacity requirements. Both the space constraints and higher capacity requirements can be met with such a flexibility in assembling the battery modules. The cell holders electrically insulate the battery modules, thereby reducing the probability of short circuit in the battery block. The use of separate insulators between the battery modules is avoided, making the battery block more compact, less bulky, and easy to transport. Such a stacked battery block has mechanically rigid connection between the modules that can absorb sudden shocks and impact and not loosen up. The attaching components and the connector key do not affect the electrical connections of the battery modules in the stack. The stack of the battery modules does not require external components such as the support structures that make the battery block bulky. The manufacturing, assembly, installation, and servicing of the battery block disclosed herein is simple, compact, durable, and cost effective. The assembly of the battery block is modular which allows for easy repair and replaceability of the individual components constituting the battery block. If incase a battery module is faulty, the battery module alone may be replaced with a spare. If one of the cell holders is faulty, replacing a cell holder is sufficient, not requiring discarding of the entire battery module of the battery block. The design of the cell holders for the battery block is the same the cell holders can be interchangeably used. The design of the connector key is simple and the connector keys can be interchangeably used. Such a universal design of the cell holder and the connector key eases the process of assembly of the battery block. The heat sink in the individual battery modules maintains the temperatures of the battery modules, reducing the probability of expansion of the metal connector key. Also, the metal connector key is tightly restricted from all sides in the connecting sockets and held in place with enough pressure by the attaching components. Also, the method of attaching of the attaching components into the connector key and the connecting socket is known in art and does not require tooling changes to be made during the manufacturing process. The battery modules in the battery block can be aligned precisely using the accurate designed connecting sockets, the connector key, and the attaching components, thereby increasing the density of the battery modules in the battery block to obtain a more compact battery block. Overall, the battery block, thus formed, is mechanically stable, compact, thermally stable, durable, vibration insensitive, and impact resistant can be used to high capacity requirements in rugged environments. Further, the method of assembly of such a battery block is time effective, cost effective, and not a cumbersome process.

Improvements and modifications may be incorporated herein without deviating from the scope of the invention.

1-11. (canceled)

12. A battery block comprising:
battery modules that each comprise:
a cell holder with a connecting socket; and
a plurality of cells in the cell holder connected in at least one of a series and a parallel connection, wherein
the battery modules are sequentially positioned in at least one of a horizontal direction and a vertical direction;
a connector key with annuli positioned in-line with the connecting socket in the cell holder of the sequentially positioned battery modules, where the connector key holds the battery modules adjacent to each other; and
attaching components that are removably engaged in the annuli of the connector key, where the attaching components stack the battery modules in at least one of the horizontal direction and the vertical direction.

13. The battery block of claim 12, further comprising
a casing for enclosing the battery modules stacked in the at least one of the horizontal direction and the vertical direction.

14. The battery block of claim 12, wherein
the cell holder comprises a rectangular planar surface surrounded by raised walls.

15. The battery block of claim 14, wherein
the connecting socket is positioned on the raised walls of the cell holder.

16. The battery block of claim 14, wherein
the battery modules include a first battery module and a second battery module, each of the first battery module and the second battery module comprises a top cell holder and a bottom cell holder, and
the connecting socket is provided at least one location of the top cell holder and the bottom cell holder of each of the first battery module and the second battery module.

17. The battery block of claim 16, wherein
when stacking the battery modules vertically, the connector key is positioned in-line with the connecting socket in a raised wall of the bottom cell holder of the first battery module and the connecting socket in a raised wall of the top cell holder of the second battery module.

18. The battery block of claim 16, wherein
when stacking the battery modules horizontally, the connector key is positioned in-line with the connecting socket rear of the planar surface of the top cell holder of the first battery module and the connecting socket rear of a planar surface of the top cell holder of the second battery module.

19. The battery block of claim 14, wherein
the plurality of cells in each of the battery modules are electrically insulated from each other by the raised walls of the cell holder of each of the battery modules.

20. The battery block of claim 12, wherein
each of the battery modules further comprises a battery management system comprising a heat sink that monitors and maintains health of the plurality of cells held in the cell holders.

21. The battery block of claim 12, wherein
the attaching components comprise an assemblage of a screw that removably engages in one of the annuli of the connector key along with a spring washer, and a plain washer.

22. A method of assembly of a battery block comprises:
obtaining battery modules that each comprise:
a cell holder with a connecting socket; and
a plurality of cells in the cell holder connected in at least one of a series and a parallel connection;
positioning the battery modules sequentially in at least one of a horizontal direction and a vertical direction;
positioning a connector key with annuli positioned in-line with the connecting socket in the cell holder of the sequentially positioned battery modules, where the connector key holds the battery modules adjacent to each other; and
attaching the connector key with attaching components that removably engaged in the annuli of the connector key, where the attaching components stack the battery modules in at least one of the horizontal direction and the vertical direction to form the battery block.
